(19) United States
(12) Patent Application Publication
(10) Pub. No.: US 2023/0011435 A1
(43) Pub. Date: Jan. 12, 2023

(54) METHOD FOR CONTROLLING A BRUSHLESS DIRECT CURRENT ELECTRIC MOTOR

(71) Applicant: Valeo Systèmes d'Essuyage, Le Mesnil Saint Denis (FR)

(72) Inventors: Xiang Liu, Le Mesnil Saint Denis (FR); Jose-Luis Herrada, Le Mesnil Saint Denis (FR); Alexandre Paschutine, Le Mesnil Saint Denis (FR); Mehdi Belhaj, Le Mesnil Saint Denis (FR)

(73) Assignee: Valeo Systèmes d'Essuyage, Le Mesnil Saint Denis (FR)

(21) Appl. No.: 17/784,956

(22) PCT Filed: Nov. 12, 2020
(86) PCT No.: PCT/EP2020/081836

§ 371 Date: Jun. 13, 2022

(30) Foreign Application Priority Data
Dec. 13, 2019 (FR) FR1914330

(51) Int. Cl. H02P 6/24; H02P 21/18

(52) U.S. Cl. CPC H02P 6/24; H02P 21/18

(57) ABSTRACT

A method for controlling a brushless and sensorless, direct current electric motor (3) for motor vehicle equipment, wherein the electric motor (3) comprises a rotor and phases (A, B, C) powered by a pulse width modulation applied to a power inverter (1) of the electric motor (3), and wherein, beyond a minimum threshold (Sₘᵢₙ) of the rotation speed of the rotor, the position of the rotor is determined from a measurement of electromotive forces at the phases (A, B, C) of the electric motor (3), said control method is characterised in that, in the event of a command (104) to stop the electric motor (3), the speed of rotation of the rotor is reduced (105) from a nominal speed to a predetermined rotation speed (V1) within a range between the minimum threshold (Sₘᵢₙ) and 10% above said minimum threshold (Sₘᵢₙ) by modifying the pulse width modulation, then the electric motor (3) is stopped (106) in a predetermined position by short-circuiting the branches (A, B, C) of the inverter (1) when the predetermined position is reached.

The present invention relates to the field of electric motors for motor vehicle equipment, and in particular to brushless DC electric motors used for wiper devices.

Controlling brushless DC motors requires ascertaining the position of the rotor at least at certain precise points in order to be able to apply a pulse width modulation command that makes it possible to achieve the desired rotational speed.

For this purpose, it is known to use position sensors and in particular Hall-effect sensors that make it possible to ascertain certain positions of the rotor.

However, in order to reduce the cost of the electric motor, it may be beneficial to dispense with these position sensors, the cost of which is non-negligible.

It is also possible to determine the position of the rotor using a zero-crossing method, by measuring the electromotive forces at the phases of the electric motor. However, it is necessary for the electric motor to be rotating at a speed greater than a predefined rotational speed in order for the electromotive forces to be high enough to allow them to be detected.

It is thus possible to drive the electric motor without a sensor by applying a predetermined command at startup until the predefined rotational speed is achieved.

However, in the case of a wiper device, it is also necessary to stop the motor in a predetermined position corresponding to a stop position (or “park position”). This stop position is generally provided by way of a sensor associated with the linkage of the wiper device. Thus, one way of stopping the electric motor is to short-circuit the branches of the inverter supplying power to the phases of the motor when the stop position is reached, in order to stop the electric motor dead. However, such a short circuit of the branches of the inverter when the electric motor is rotating at its nominal speed produces significant current peaks that may damage the transistors used in the inverter, and thus lead to failure of the electric motor. One way of overcoming this problem is to oversize the transistors so as to be able to withstand these current peaks, but this involves a significant cost that goes against the desire to reduce the overall cost of the electric motor.

It is therefore necessary to find a solution that makes it possible to control a brushless and sensorless electric motor while still allowing the electric motor to be stopped in a predetermined position and without damaging the transistors used for supplying power to the electric motor.

To this end, what is proposed is a method for controlling a brushless and sensorless DC electric motor for motor vehicle equipment, wherein the electric motor comprises a rotor and phases supplied with power by pulse width modulation applied to an inverter of the electric motor and wherein, beyond a minimum threshold for the rotational speed of the rotor, the position of the rotor is determined from a measurement of electromotive forces at the phases of the electric motor,

characterized in that, in the event of a command to stop the electric motor, the rotational speed of the electric motor is reduced from a nominal speed to a second predetermined rotational speed within an interval between the first predetermined rotational speed and 10% above said first predetermined rotational speed by modifying the pulse width modulation, and then the motor is stopped in a predetermined position by short-circuiting the branches of the inverter when the predetermined position is reached.

The use of a method for controlling a brushless and sensorless electric motor, wherein, when the electric motor is stopped, the speed is reduced to a rotational speed substantially equal to the minimum speed for which the electromotive forces at the phases of the motor are able to be measured in order to detect the position of the rotor and then to short-circuit the branches of the inverter to stop the motor when the desired stop position is reached, thereby making it possible to reduce the intensity of the current peaks generated when the branches of the inverter are short-circuited. This advantageously makes it possible to stop the electric motor in the desired position without damaging the transistors used to supply power to the electric motor.

According to one mode of implementation, the reduction of the rotational speed to the predetermined rotational speed comprises a plurality of increments associated with various reductions of the rotational speed of the electric motor.

According to another mode of implementation, the electric motor is associated with a gear reduction device so as to form a geared motor configured so as to drive a motor vehicle wiper device comprising at least one wiper arm. Said wiper device comprises a stop sensor associated with a stop position of the wiper arm. The predetermined position is given by the stop sensor, and a signal from the stop sensor is used to determine the time from which the rotational speed should be reduced.

According to another mode of implementation, the stop sensor is modified so as to provide a deceleration position from which the rotational speed of the electric motor should be reduced in order to allow the wiper device to be stopped in the stop position, for example 5° or 10° before the stop position.

According to another mode of implementation, the position of the wiper arm is deduced from the position of the rotor determined by the electromotive forces and from the gear reduction ratio of the gear reducer when the rotational speed of the electric motor is greater than the minimum threshold.

The present invention also relates to a geared motor for a motor vehicle wiper device comprising a brushless and sensorless DC electric motor, wherein the electric motor comprises a rotor, a control unit, and phases supplied with power by pulse width modulation applied to an inverter of the electric motor. The control unit is configured so as to determine the position of the rotor from a measurement of electromotive forces at the phases of the electric motor beyond a minimum threshold for the rotational speed of the rotor.

In the event of a command to stop the electric motor, the control unit is configured so as to reduce the rotational speed of the electric motor from a nominal speed to a predetermined rotational speed within an interval between said minimum threshold and 10% above said minimum threshold by modifying the pulse width modulation, and then to stop the electric motor in a predetermined position by short-circuiting the branches of the inverter when the predetermined position is reached.

According to one embodiment, the predetermined position is given by a stop sensor associated with a stop position of the wiper device, the control unit being configured so as to use an output signal from said stop sensor so as to determine the time from which the rotational speed of the rotor should be reduced.

According to another embodiment, the stop sensor is modified so as to provide a deceleration position from which the rotational speed of the electric motor should be reduced in order to allow the wiper device to be stopped in the stop position.

The present invention also relates to a wiper device, in particular for a motor vehicle, comprising a geared motor as described above.

Further features and advantages of the invention will become more clearly apparent upon reading the following description, which is given by way of illustrative and non-limiting example, and the appended drawings, in which:

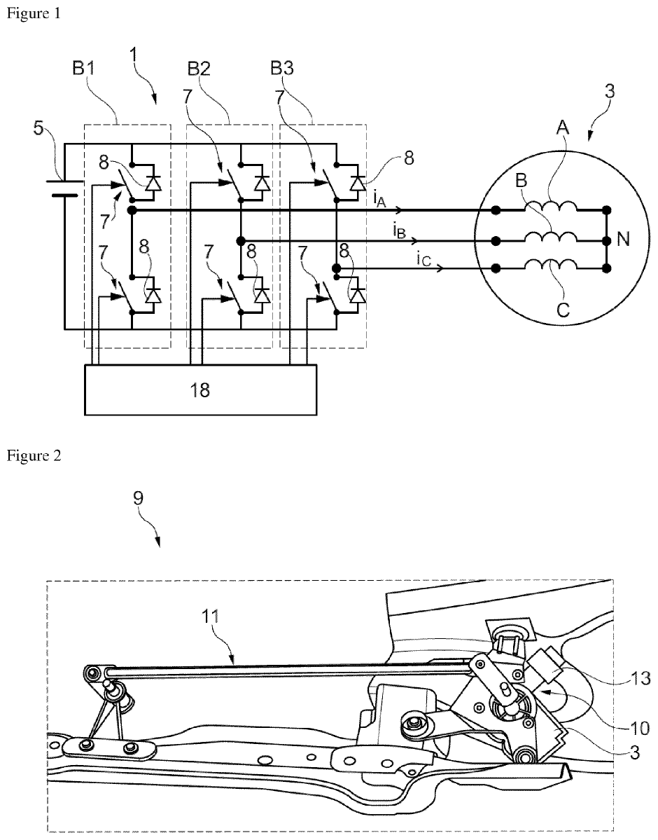

FIG. 1 shows a schematic view of an electric motor and its control inverter;

FIG. 2 shows a schematic perspective view of part of a wiper device;

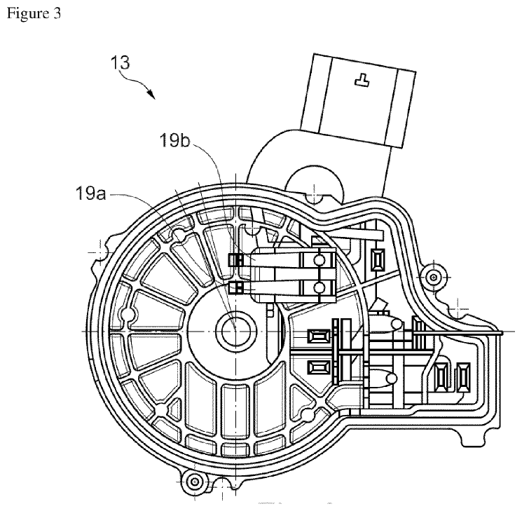

FIG. 3 shows a schematic view of part of a stop sensor;

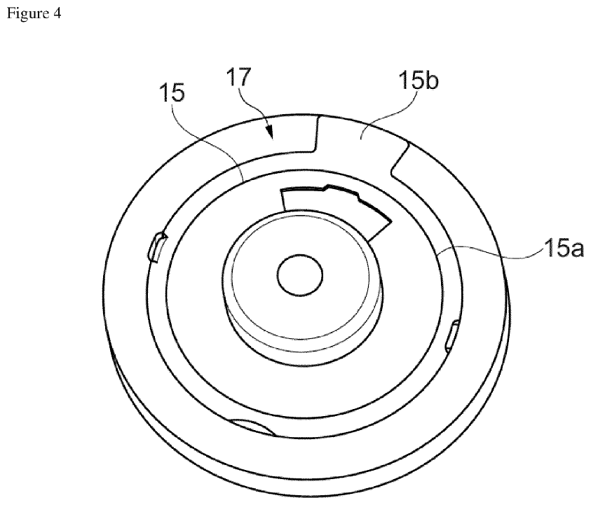

FIG. 4 shows a schematic view of a wheel equipped with a metal track of a stop sensor;

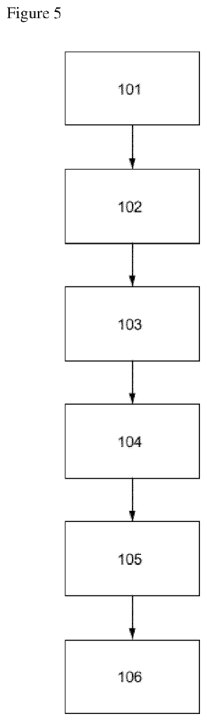

FIG. 5 shows a flowchart of the steps of the method for controlling an electric motor.

In these figures, identical elements have the same reference signs.

The following embodiments are examples. Although the description refers to one or more embodiments, this does not necessarily mean that each reference relates to the same embodiment, or that the features apply only to one embodiment. Individual features of various embodiments may also be combined or interchanged in order to create other embodiments.

The present invention relates to a method for controlling an electric motor for a motor vehicle wiper device.

FIG. 1 shows a circuit diagram of a power supply inverter 1 for a three-phase electric motor 3, in particular an electric motor 3 for a motor vehicle wiper device. The inverter 1 comprises three branches, denoted B1, B2 and B3, configured so as to supply power respectively to the three phases A, B and C of the electric motor 3, each of the branches B1, B2, B3 being connected to a positive terminal of a power source 5, such as a vehicle battery, on the one hand, and to the ground corresponding to the negative terminal of the power source 5, on the other hand. Each branch B1, B2, B3 comprises two switches 7, generally formed by a transistor, connected in series. A diode 8 is generally arranged in parallel with each transistor 7. The center tap between the two transistors 7 of the respective branches B1, B2, B3 is connected to a respective phase A, B, C of the electric motor 3.

In order to control the rotation of the electric motor 3, a pulse width modulation command is applied to the phases A, B, C of the electric motor 3. This command is applied by commanding the opening and closing of the transistors 7 via a control unit 18. During normal operation, the two switches 7 of a branch B1, B2, B3 are in an opposite state (one is open while the other is closed). Moreover, there is always a phase A, B or C that is not supplied with power (the switch 7 connected to the positive terminal of the power source in the open position).

The electric motor 3 comprises a rotor. When the rotor rotates fast enough, that is to say at a speed greater than a minimum threshold Sₘᵢₙ for the rotational speed of the rotor, it is possible to measure the electromotive force at the phase A, B or C that is not supplied with power and to deduce the position of the rotor of the electric motor 3 by detecting a time when the measured voltage passes to zero, called the “zero-crossing” technique.

The pulse width modulation command is for example applied by a control unit 18 for controlling the electric motor 3. In addition, when the electric motor 3 is started up, it is possible to apply a predetermined sequence of commands that make it possible to reach the rotational speed Sₘᵢₙ without needing to ascertain the position of the rotor, and therefore without using a position sensor. In the same way, it is possible to apply another predetermined sequence of commands in order to stop the motor without requiring a position sensor, but such a method does not make it possible to stop the electric motor 3 in the desired stop position.

FIG. 2 shows a diagram of a wiper device 9 for a motor vehicle. The wiper device 9 comprises an electric motor 3 controlled by an inverter 1 as shown in FIG. 1. A gear reduction mechanism (not visible) is arranged at the output of the electric motor 3 so as to form a geared motor 10. The gear reduction ratio of the gear reducer is for example 1/69°. The output of the gear reducer is connected to a linkage 11 that enables the mechanical connection between the output of the gear reducer and the one or more wiper arms (not shown) of the wiper device 9. The linkage 11 comprises for example a set of connecting rods and cranks that make it possible to convert the rotational movement of the electric motor 3 into a reciprocating movement of the one or more wiper arms. In order to ensure that the wiper arms are stopped in a predefined stop position, a stop sensor 13, also called a “park finger”, is arranged in the wiper device 11, for example in the linkage 11 or at the output of the gear reducer.

FIGS. 3 and 4 show one exemplary embodiment of such a stop sensor 13. The sensor 13 comprises a metal and therefore electrically conductive track 15, having for example a resistance of less than 10 mohm. The metal track 15 is arranged on a wheel 17 that is made of a non-conductive material, for example plastic. The metal track 15 comprises a circular portion 15a from which an appendage 15b extends outward over a limited angular portion. The sensor 13 also comprises two contacts 19a and 19b, formed for example by two metal blades, configured so as to come into contact with the metal track 15. The first contact 19a is configured so as to come into contact with the circular portion 15a of the metal track 15 and to be in permanent contact with the metal track 15, while the second contact 19b is configured so as to come into contact with the appendage 15b such that the second contact is in contact with the metal track 15 only in the limited angular portion corresponding to the appendage 15b and in contact with the non-conductive wheel 17 the rest of the time.

Thus, by measuring the electrical resistance between the two contacts 19a and 19b, it is possible to detect the times at which the appendage 15b of the metal track 15 is in contact with the second contact 19b, since the resistance between the two contacts 19a and 19b becomes substantially zero due to the conductive nature of the metal track 15. The wheel 17 is thus configured such that the angular region associated with the appendage 15b corresponds to the stop position. It is nevertheless possible to modify the configuration of the wheel (and in particular of the metal track 15) such that the position of the appendage 15b corresponds to a position other than the stop position, for example 5° or 10° before the stop position.

According to a first embodiment, in order to limit the intensity of these current peaks when the electric motor 3 is stopped, the stop sensor 13 is modified such that the appendage corresponds to a deceleration position located before the stop position, for example 5° or 10° before the stop position. In addition, during operation and when the wiper device 11 is stopped, when the deceleration position is reached and detected via the stop sensor 13, the control unit 18 is configured so as to reduce the rotational speed of the electric motor 3. The control unit 18 is therefore configured so as to receive and use an output signal from the stop sensor 13. The rotational speed of the electric motor 3 is reduced to a predetermined rotational speed V₁ corresponding to the minimum threshold Sₘᵢₙ, for which the position of the rotor is able to be determined from the electromotive forces measured at the phases A, B, C or a speed slightly greater than this minimum threshold Sₘᵢₙ. The predetermined rotational speed V₁ is for example within an interval between the minimum threshold Sₘᵢₙ and a rotational speed 10% greater than the minimum threshold Sₘᵢₙ.

Thus, when the electric motor 3 is stopped, the speed is first reduced so as to change from a nominal operating speed (there are generally multiple nominal speeds) to a speed close to the minimum threshold Sₘᵢₙ. The reduction from the nominal speed to the predetermined rotational speed V₁ may be implemented in a substantially linear manner or in increments, passing through various intermediate speeds for various predetermined positions so as to reach the predetermined speed V₁ just before reaching the stop position. In particular, the configuration of the increments may be different depending on the nominal speed at the time when the command to stop the electric motor 3 is transmitted.

The control unit 18 is configured so as to stop the rotor of the electric motor 3 by short-circuiting the branches B1, B2, B3 of the inverter 1 when the stop position is reached. This stop position is determined from the electromotive forces measured at the phases of the electric motor 3 and from the gear reduction ratio of the gear reducer.

Indeed, the electromotive forces make it possible to determine the position of the rotor (this being possible because the predetermined rotational speed is greater than the minimum threshold Sₘᵢₙ) and the gear reduction ratio makes it possible to deduce the position of the one or more wiper arms from the position of the rotor.

Short-circuiting the branches of the inverter 1 when the stop position is reached thus leads to current peaks of low intensity due to the reduced rotational speed (in comparison with a nominal rotational speed of the electric motor 3).

According to a second embodiment, the stop sensor 13 is not modified and indicates the stop position. The first predetermined position is then determined from the position of the rotor as estimated from the electromotive forces and the gear reduction ratio of the gear reducer.

Indeed, as indicated above, the position of the one or more wiper arms may be estimated from the position of the rotor as determined from the electromotive forces when the rotational speed of the electric motor is sufficient, in other words greater than said minimum threshold Sₘᵢₙ.

However, since the determination of the position of the rotor is a measurement of a relative position, it is necessary to use the stop sensor 13 to have a position reference. All types of sensorless control, for example the measurement of electromotive forces, make it possible to estimate the position of the wiper arm between two stop positions of the one or more wiper arms. This makes it possible in particular to determine the position of the arm just before it reaches the stop position, for example so as to reach the first predetermined position located 5° before the stop position. The speed is then reduced to the predetermined rotational speed V₁ when the estimated position corresponds to the first predetermined position. Next, when the stop position, given by the stop sensor 13, is reached (at the speed V₁), the branches B1, B2, B3 of the inverter 1 are short-circuited in order to stop the electric motor 3 in this stop position. In the same way as the previous embodiment, the current peaks generated in the transistors 7 of the inverter 1 are reduced (in comparison with the peaks generated when the short-circuit is produced when the electric motor 13 is rotating at a nominal speed).

The various steps of the method for controlling an electric motor 3 of a wiper device as described above will now be described based on FIG. 5. The present invention relates more specifically to controlling the electric motor 3 when it is stopped, but the steps associated with the startup and the nominal operation of the electric motor 3 will also be described.

The first step 101 concerns activating the wiper device 11. This activation corresponds for example to the actuation of a manual command by a user of the vehicle, which causes an activation signal to be sent to the control unit 18.

The second step 102 concerns starting up the electric motor 3. Following the receipt of an actuation command, the control unit 18 for controlling the electric motor 3 applies a predetermined sequence of pulse width modulation commands to the inverter 1. This step may be performed with or without knowledge of the position of the rotor of the electric motor 3.

The third step 103 concerns stabilizing the rotational speed of the electric motor 3 at a nominal speed. This nominal speed is greater than the minimum threshold Sₘᵢₙ, meaning that the pulse width modulation control for achieving this nominal speed is implemented by virtue of the position of the rotor as determined from the electromotive forces measured at the branches of the inverter 1. The wiper device 1 may comprise multiple nominal speeds, generally two, such that the user is able to change nominal speed over time as needed. The electric motor 3 is regulated in all cases using the electromotive forces measured at the branches B1, B2, B3 of the inverter 1.

The fourth step 104 concerns a command to stop the wiper device 1. This command corresponds for example to a manual command from the user, which causes a stop signal to be sent to the control unit 18.

The fifth step 105 concerns reducing the rotational speed of the electric motor 3 to the predetermined rotational speed. This reduction is performed when the wiper device 1 is in a predetermined position, for example 5° before the stop position.

According to a first mode of implementation, this position is given by the stop sensor 13, modified so as to detect this predetermined position, in other words the deceleration position.

According to a second mode of implementation, this position is determined from the estimated position of the rotor by virtue of the electromotive forces measured at the branches B1, B2, B3 of the inverter 1, the gear reduction ratio of the gear reducer and the previous signal from the stop sensor 13.

The reduction of the rotational speed may be linear or incremental (a first speed reduction is applied between the positions −15° and −10° (before the stop position, which corresponds to a 0° reference position) and then a second speed reduction is applied between the positions −10° and −5°). A non-linear reduction may also be applied.

The sixth step 106 concerns stopping the electric motor 3 in the stop position by short-circuiting the branches B1, B2, B3 of the inverter 1 when the stop position is reached.

According to the first mode of implementation, the reaching of the stop position is determined from the estimated position of the rotor by virtue of the electromotive forces measured at the branches B1, B2, B3 of the inverter 1, the gear reduction ratio of the gear reducer and the previous signal from the stop sensor 13 corresponding to the position 5°.

According to the second embodiment, the stop position is given by the stop sensor 13. The short-circuiting of the branches B1, B2, B3 of the inverter 1 leads to very rapid stoppage of the electric motor 3, therefore corresponding to stoppage of the wiper device 11 in the stop position. In addition, owing to the reduced speed before the short-circuiting, the current peaks generated in the transistors 7 of the inverter 1 are reduced, thereby making it possible to avoid the use of oversized transistors 7 and thus limit the cost of inverter 1.

The management of the stoppage of the electric motor 3 of the wiper device 11 as described above thus makes it possible to use a brushless and sensorless DC electric motor 3 in such a device while at the same time using transistors 7 of limited capacity and therefore having a limited cost. The overall cost of the wiper device 11 may thus be reduced while still keeping the same operating quality for the user (stopping the wiper arm in the stop position).

1. A method for controlling a brushless and sensorless DC electric motor for motor vehicle equipment, wherein the electric motor comprises a rotor and phases supplied with power by pulse width modulation applied to an inverter for supplying power to the electric motor and wherein, beyond a minimum threshold for the rotational speed of the rotor, the position of the rotor is determined from a measurement of electromotive forces at the phases of the electric motor, the method comprising:
in the event of a command to stop the electric motor, reducing the rotational speed of the rotor is from a nominal speed to a predetermined rotational speed within an interval between the minimum threshold and 10% above said minimum threshold by modifying the pulse width modulation; and
stopping the electric motor in a predetermined position by short-circuiting the branches of the inverter when the predetermined position is reached.

2. The control method as claimed in claim 1, wherein the reduction of the rotational speed of the rotor to the predetermined rotational speed comprises a plurality of increments associated with various reductions of the rotational speed of the electric motor.

3. The control method as claimed in claim 1, wherein the electric motor is associated with a gear reduction device so as to form a geared motor configured so as to drive a motor vehicle wiper device comprising at least one wiper arm, said wiper device comprising a stop sensor associated with a stop position of the wiper arm, and wherein the predetermined position is given by the stop sensor, and an output signal from the stop sensor is used to determine the time from which the rotational speed of the rotor should be reduced.

4. The control method as claimed in claim 3, wherein the stop sensor is modified so as to provide a deceleration position from which the rotational speed of the electric motor should be reduced in order to allow the wiper device to be stopped in the stop position, for example 5° or 10° before the stop position.

5. The control method as claimed in claim 3, wherein the position of the wiper arm is deduced from the position of the rotor determined by the electromotive forces and from the gear reduction ratio of the gear reducer when the rotational speed of the rotor is greater than the minimum threshold.

6. A geared motor for driving a motor vehicle wiper device comprising:
a gear reduction device; and
a brushless and sensorless DC electric motor,
wherein the electric motor comprises a rotor, a control unit and phases supplied with power by pulse width modulation applied to an inverter of the electric motor, and
wherein the control unit is configured so as to determine the position of the rotor from a measurement of electromotive forces at the phases of the electric motor beyond a minimum threshold for the rotational speed of the rotor,
wherein, in the event of a command to stop the electric motor, the control unit is configured so as to reduce the rotational speed of the rotor from a nominal speed to a predetermined rotational speed within an interval between the minimum threshold and 10% above said minimum threshold by modifying the pulse width modulation, and then to stop the electric motor in a predetermined position by short-circuiting the branches of the inverter when the predetermined position is reached.

7. The geared motor as claimed in claim 6, wherein the predetermined position is given by a stop sensor associated with a stop position of the wiper device, the control unit being configured so as to use an output signal from said stop sensor so as to determine the time from which the rotational speed of the rotor should be reduced.

8. The geared motor as claimed in claim 7, wherein the stop sensor is modified so as to provide a deceleration position from which the rotational speed of the electric motor should be reduced in order to allow the wiper device to be stopped in the stop position.

9. The geared motor as claimed in claim 7, wherein the control unit is configured so as to deduce the position of the wiper arm from the position of the rotor determined by the electromotive forces and from the gear reduction ratio of the gear reduction device when the rotational speed of the rotor is greater than the minimum threshold.

10. A wiper device for a motor vehicle, comprising a geared motor as claimed in claim 6.
